(19) United States
(12) Patent Application Publication
(10) Pub. No.: US 2006/0007356 A1
(43) Pub. Date: Jan. 12, 2006

(54) Method and system for maintaining lip synchronization

(75) Inventors: Phillip Aaron Junkersfeld, Carmel, IN (US); Devon Matthew Johnson, Fishers, IN (US)

Correspondence Address: THOMSON LICENSING INC., PATENT OPERATIONS, PO BOX 5312, PRINCETON, NJ, 08543-5312, US

(73) Assignee: Thomson Licensing S.A., Boulogne-Billancourt (FR)

(21) Appl. No.: 10/531,695

(22) PCT Filed: Oct. 22, 2003
(86) PCT No.: PCT/US03/33451

§ 371 Date: Apr. 18, 2005

Related U.S. Application Data
(60) Provisional application No. 60/420,871, filed on Oct. 24, 2002.

(51) Int. Cl. H04N 9/475

(52) U.S. Cl. 348/515

(57) ABSTRACT

The disclosed embodiments relate to a system and method for maintaining synchronization between a video signal and an audio signal. The video signal and the audio signal are processed using clocks that a r e locked. The system may comprise a component that determines an initial audio input buffer level, a component that determines an amount of drift in the initial audio input buffer level and adjusts the clocks to maintain the initial audio input buffer level if the amount of drift reaches a first predetermined threshold, and a component that measures a displacement of a video signal associated with t h e audio signal in response to the adjusting of the clocks and operates to negate the measured displacement of the video signal if the measured displacement reaches a second predetermined threshold.

### PRIORITY CLAIM

This application claims the benefit of U.S. Provisional Application No. 60/420,871, filed Oct. 24, 2002, entitled “A METHOD AND SYSTEM FOR MAINTAINING LIP SYNCH,” which is incorporated herein by reference.

### FIELD OF THE INVENTION

This invention relates to the field of maintaining synchronization between audio and video signals in an audio/video signal receiver.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Some audio/video receiver modules, which may be incorporated into display devices such as televisions, have been designed with an audio output digital to analog (D/A) clock that is locked to a video output D/A clock. This means that the audio clock and video clock cannot be controlled separately. A single control system may variably change the rate of both clocks by an equal percentage. In some of these systems, a clock recovery system may match the video (D/A) clock to the video source analog to digital (A/D) clock. The audio output D/A clock may then be assumed to match to the audio source A/D clock.

This assumption is based upon the fact that broadcasters are supposed to similarly lock their audio and video clocks when the source audio and video is generated.

Although the Advanced Television Systems Committee (ATSC) specification requires broadcasters to lock their video source A/D clock to their audio source A/D clock, there have been instances where these clocks were not locked. Failure of broadcasters to lock the clock of transmitted audio source material with the clock of transmitted video source material may result in a time way between when the audio presentation should be occurring and when the audio is actually presented. This error, which may be referred to as lip synchronization or lip sync error, may cause the sound presented by the audio/video display device to not match the picture as it is displayed. This effect is annoying to many viewers.

When the audio/video clock recovery is driven by matching the video output rate to the video input rate, the only way to compensate for lip sync error is to time-manipulate the audio output. Because audio is a continuous time presentation, it is difficult to time-manipulate the audio output without have some type of audible distortion, mute, or skip. The frequency of these unwanted audible disturbances is dependent upon the frequency difference between the relative unlocked audio and video clocks at the broadcast station. ATSC sources have been observed to mute the audio every 2-3 minutes. The periodic muting of the audio signal may produce undesirable results to the viewer of the television.

Various televisions, including High Definition Televisions (HDTVs), have been exercised with an unlocked ATSC source and it has been observed that the HDTVs do some type of audio shift to correct the growing lip sync error. Instead of muting during the audio shift, the HDTVs actually inject some type of static noise that masks the mute and is relatively equal in amplitude to the audio amplitude. The introduction of this static noise into the signal may produce undesirable results to the viewer of the television.

### SUMMARY OF THE INVENTION

The disclosed embodiments relate to a system and method for maintaining synchronization between a video signal and an audio signal. The video signal and the audio signal are processed using clocks that are locked. The system may comprise a component that determines an initial audio input buffer level, a component that determines an amount of drift in the initial audio input buffer level and adjusts the clocks to maintain the initial audio input buffer level if the amount of drift reaches a first predetermined threshold, and a component that measures a displacement of a video signal associated with the audio signal in response to the adjusting of the clocks and operates to negate the measured displacement of the video signal if the measured displacement reaches a second predetermined threshold.

### BRIEF DESCRIPTION OF THE DRAWINGS

In the drawings:

FIG. 1 is a block diagram of an exemplary system in which the present invention may be implemented;

FIG. 2 is a graphical illustration corresponding to buffer control tables that may be implemented in embodiments of the present invention; and

FIG. 3 is a flow diagram illustrating a process in accordance with embodiments of the present invention.

### DETAILED DESCRIPTION OF THE PREFERRED EMBODIMENT

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present invention allows an audio/video receiver (for example, digital TVs, including HDTV) to present audio and video in synchronization when the source audio clock and source video clock are not locked and the digital TV audio and video clocks are locked. Moreover, the present invention may be useful for maintaining lip sync with unlocked audio and video clocks of digital sources, such as Moving Pictures Experts Group (MPEG) sources.

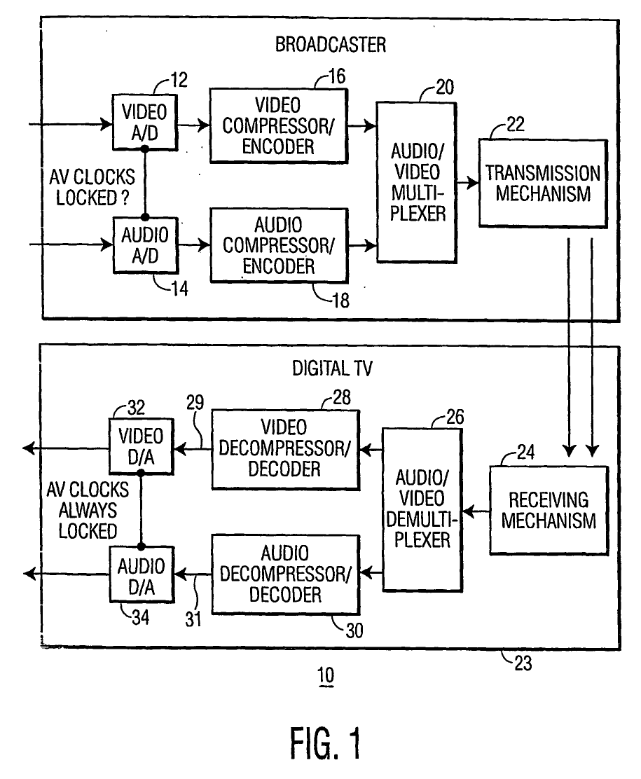

FIG. 1 is a block diagram of an exemplary system in which the present invention may be implemented. The system is generally referred to by the reference numeral 10. Those of ordinary skill in the art will appreciate that the components shown in FIG. 1 are for purposes of illustration only. Systems that embody the present invention may be implemented using additional elements or subsets of the components shown in FIG. 1. Additionally, the functional blocks shown in FIG. 1 may be combined together or separated further into smaller functional units.

A broadcaster site includes a video A/D converter 12 and an audio A/D converter 14, which respectively process a video signal and a corresponding audio signal prior to transmission. The video A/D converter 1 2 and the audio A/D converter 14 are operated by separate clock signals. As shown in FIG. 1, the clocks for the video A/D converter 12 and the audio A/D converter 14 are not necessarily locked. The video A/D converter 12 may include a motion-compensated predictive encoder utilizing discrete cosine transforms. The video signal is delivered to a video compressor/encoder 16 and the audio signal is delivered to an audio compressor/encoder 18. The compressed video signal may be arranged, along with other ancillary data, according to some signal protocol such as MPEG or the like.

The outputs of the video compressor/encoder 16 and the audio compressor/encoder 18 are delivered to an audio/video multiplexer 20. The audio/video multiplexer 20 combines the audio and video signals into a single signal for transmission to an audio/video receiving unit. As will be appreciated by those of ordinary skill in the art, strategies such as time division multiplexing may be employed by the audio/video multiplexer 20 to combine the audio and video signals. The output of the audio/video multiplexer 20 is delivered to a transmission mechanism 22, which may amplify and broadcast the signal.

An audio/video receiver 23, which may comprise a digital television, is adapted to receive the transmitted audio/video signal from the broadcaster site. The signal is received by a receiving mechanism 24, which delivers the received signal to an audio/video demultiplexer 26. The audio/video multiplexer 26 demultiplexes the received signal into video and audio components. A demultiplexed video signal 29 is delivered to a video decompressor/decoder 28 for further processing. A demultiplexed audio signal 31 is delivered to an audio decompressor/decoder 30 for further processing.

The output of the video decompressor/decoder 28 is delivered to a video D/A converter 32 and the output of the audio decompressor/decoder 30 is delivered to an audio D/A converter 34. As shown in FIG. 1, the clocks of the video D/A converter 32 and the audio D/A converter 34 are always locked. The outputs of the video D/A converter 32 and the audio D/A converter 34 are used to respectively create a video image and corresponding audio output for the entertainment of a viewer.

Even though the hardware in the exemplary system of FIG. 1 does not allow for separate control of the audio and video presentation, it has the ability, using embodiments of the present invention, to determine if such control is necessary. In accordance with embodiments of the present invention, the relative transport timing associated with the received audio and video signals is measured by observing the level of the received audio buffer. The level of the audio buffer has been observed to be a relatively accurate measure of lip sync error.

If audio and video signals are properly synchronized initially, then received video data and audio data should be consumed at the same rate during playback. In that case, the buffer that holds audio information should remain at about the same size over time without growing. If the audio buffer does grow or shrink in excess of a typically stable range, this is an indication that proper lip sync may be compromised. For example, if the audio buffer grows beyond a typical range over time, this is an indication that the video signal may be leading the audio signal. If the audio buffer shrinks below its typical range, this is an indication that the video signal may be lagging the audio signal. When the lip sync error is determined to be near zero over time (i.e. the audio buffer remains at a relatively constant size over time), it may be assumed that the audio AID source clock was locked to the video AID source clock. If lip sync error grows over time, then the audio AID and video AID source clocks were not necessarily locked and correction may be required.

Those of ordinary skill in the art will appreciate that embodiments of the present invention may be implemented in software, hardware, or a combination thereof. Moreover, the constituent parts of the present invention may be disposed in the video decompressor/decoder 28, the audio decompressor/decoder 30, the video D/A converter 32 and/or the audio D/A converter 34 or any combination thereof. Additionally, the constituent components or functional aspects of the present invention may be disposed in other devices that are not shown in FIG. 1.

Whenever a new audio/video presentation begins, usually during a channel change, embodiments of the present invention may store the initial audio D/A input buffer level into memory. This data may be stored within the video D/A converter, the audio D/A converter 34 or external thereto.

If the audio source clock is locked to the video source, then the buffer level should remain relatively constant over time. If the buffer level is drifting and the drift corresponds to a lip sync error beyond roughly ±10 ms, the normal clock recovery control may be disabled and the locked clocks of the video D/A converter 32 and the audio D/A converter 34 may be moved in a direction that returns the audio buffer level to its initial level.

While this process returns the audio buffer to its initial level, the degree to which the video is being moved from its original position is also measured. When the video is displaced by roughly ±25 ms, the process may either repeat (for example, by re-initializing the measurement of the initial audio input buffer level) or drop a video frame (e.g., an MPEG frame of the received video) to negate the measured displacement.

The process continues in the mode of locking the audio output to the audio source and skipping or repeating video frames to negate any video drift until another channel change is detected. After a new channel change, embodiments of the present invention may cease to correct lip sync error, allowing the system to return to a conventional method of locking video output to video input until a new lip sync error is detected.

The algorithm used to control the locked audio and video output clocks based upon the initial audio output D/A input buffer level and the actual audio output D/A input buffer level is very important for stable performance. It is preferred to have a response where the buffer level is turned around quickly when it is moving away from the target, moves quickly towards the target when it is relatively far away, and decelerates as it approaches the desired position. This may be accomplished, for example, by creating two control tables that relate the clock frequency change to relative position and rate of change.

Table 1 relates the clock frequency change to the relative rate of change:

TABLE 1

| Frequency Change (Hz) | Relative Rate of Change (Bytes) |
|---|---|
| −430 | v < −2000 |
| −354 | −2000 < v < −1800 |
| −286 | −1800 < v < −1600 |
| −226 | −1600 < v < −1400 |
| −174 | −1400 < v < −1200 |
| −130 | −1200 < v < −1000 |
| −94 | −1000 < v < −800 |
| −62 | −800 < v < −600 |
| −46 | −600 < v < −400 |
| −34 | −400 < v < −200 |
| 0 | −200 < v < 200 |
| 34 | 200 < v < 400 |
| 46 | 400 < v < 600 |
| 62 | 600 < v < 800 |
| 94 | 800 < v < 1,000 |
| 130 | 1000 < v < 1200 |
| 174 | 1200 < v < 1400 |
| 226 | 1400 < v < 1600 |
| 286 | 1600 < v < 1800 |
| 354 | 1800 < v < 2000 |
| 430 | 2000 < v |

TABLE 2

| Frequency Change (Hz) | Relative Distance (Bytes) |
|---|---|
| −100 | x < −4000 |
| −90 | −4000 < x < −3600 |
| −80 | −3600 < x < −3200 |
| −70 | −3200 < x < −2800 |
| −60 | −2800 < x < −2400 |
| −50 | −2400 < x < −2000 |
| −40 | −2000 < x < −1600 |
| −30 | −1600 < x < −1200 |
| −20 | −1200 < x < −800 |
| −10 | −800 < x < −400 |
| 0 | −400 < x < 400 |
| 10 | 400 < x < 800 |
| 20 | 800 < x < 1200 |
| 30 | 1200 < x < 1600 |
| 40 | 1600 < x < 2000 |
| 50 | 2000 < x < 2400 |
| 60 | 2400 < x < 2800 |
| 70 | 2800 < x < 3200 |
| 80 | 3200 < x < 3600 |
| 90 | 3600 < x < 4000 |
| 100 | 4000 < x |

Those of ordinary skill in the art will appreciate that the values shown in Table 1 and 2 are exemplary and should not be construed to limit the present invention. Since the buffer level has an irregular input rate due to the audio decode and a very regular output rate due to the D/A output clock, the buffer level data will have some erratic jitter. In order to eliminate some of this jitter, the buffer level is estimated to be the midpoint between the largest buffer reading and the smallest buffer reading over a 30 second time period. This midpoint may be calculated periodically (for example, every 30 seconds) and may give a good reading of the difference between the audio source A/D clock frequency and the audio output D/A clock frequency over time.

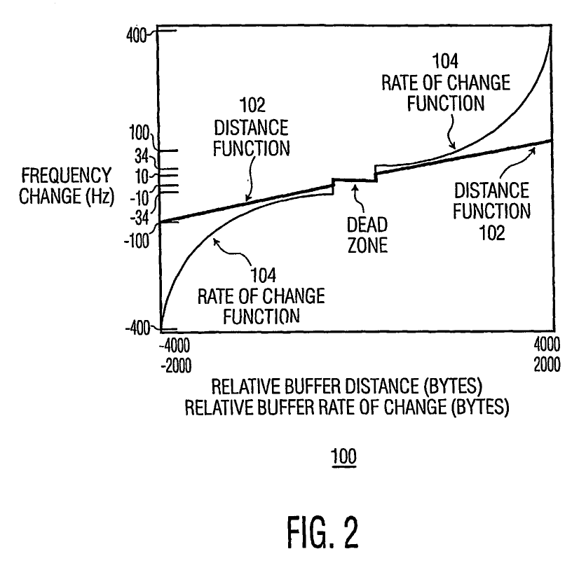

Referring now to FIG. 2, a chart graphically illustrating the buffer control tables (discussed above) is shown. The chart is generally referred to by the reference numeral 100. A distance function 102 and a rate of change function 104 are illustrated in FIG. 2. The y-axis of the chart 100 corresponds to a relative frequency change in hertz. The x-axis of the chart 100 corresponds to the relative buffer distance in bytes for the distance function 102 and the relative buffer rate of change in bytes for the rate of change function 104. Those of ordinary skill in the art will appreciate that the values shown in the chart 100 are exemplary and should not be construed to limit the present invention.

The chart 100 illustrates how embodiments of the present invention will cause the frequency compensation to be relatively large in the proper direction when the buffer level is far away from the initial position and the rate of change is in the wrong direction. This large frequency compensation will continue until the rate of change switches and the buffer level moves in the correct direction. At this point the velocity component will begin to work against the position component. However, as long as the position component is greater than the rate of change component, the frequency will be pushed to increase the rate of change towards the target and the distance will decrease. Once the rate of change component becomes larger than the distance component, the rate of change will begin to decrease. This action will serve to smoothly brake the rate of change as the distance component approaches the desired initial buffer level.

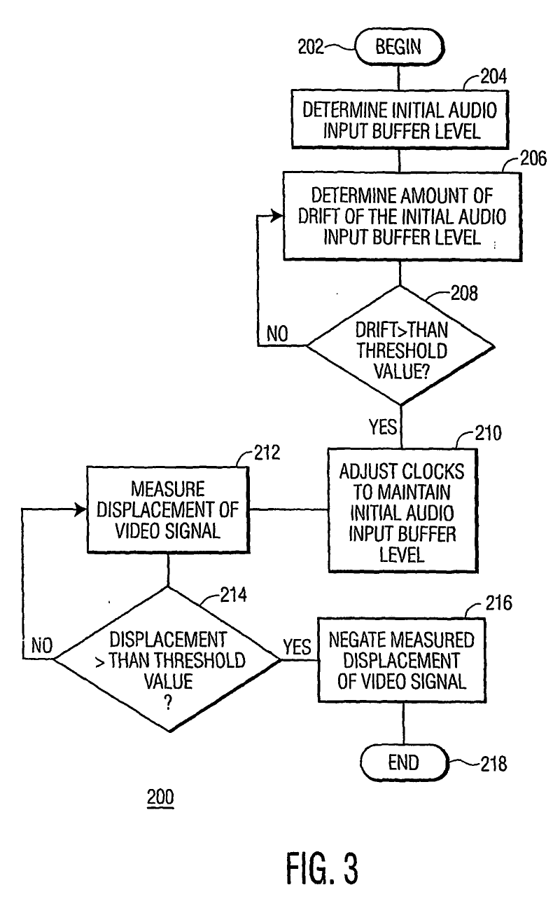

FIG. 3 is a flow diagram illustrating a process in accordance with embodiments of the present invention. The process is generally referred to by the reference numeral 200. At block 202, the process begins.

At block 204, the initial audio input buffer level is determined. Over time, the amount of drift of the initial audio input buffer level is determined, as shown at block 206. If the drift exceeds a first predetermined threshold (208), then the locked clocks of the video D/A converter 32 (FIG. 1) and the audio D/A converter 34 are adjusted in the direction that maintains the initial audio input buffer level.

In response to the adjustment of the clocks, the displacement of the video signal is measured, as shown at block 212. If the displacement of the video signal exceeds a second predetermined threshold (214), then the measured displacement of the video signal is negated (block 216) by, for example, restarting the process or dropping a video frame to improve synchronization. At block 218, the process ends.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system that maintains synchronization between a video signal and an audio signal that are processed using clocks that are locked, the system comprising:
a component that determines an initial audio input buffer level;
a component that determines an amount of drift in the initial audio input buffer level and adjusts the clocks to maintain the initial audio input buffer level if the amount of drift reaches a first predetermined threshold; and
a component that measures a displacement of a video signal associated with the audio signal in response to the adjusting of the clocks and operates to negate the measured displacement of the video signal if the measured displacement reaches a second predetermined threshold.

2. The system set forth in claim 1, wherein the initial audio input buffer level is stored in a memory.

3. The system set forth in claim 1, wherein a clock recovery control is disabled if the amount of drift reaches the first predetermined threshold.

4. The system set forth in claim 1, wherein the audio signal and the video signal comprise a Motion Picture Experts Group (MPEG) signal.

5. The system set forth in claim 1, wherein the component that measures the displacement of the video signal associated with the audio signal operates to negate the measured displacement of the video signal by re-initializing the measurement of the initial audio input buffer level.

6. The system set forth in claim 1, wherein the component that measures the displacement of the video signal associated with the audio signal operates to negate the measured displacement of the video signal by dropping a frame of the video signal.

7. The system set forth in claim 1, wherein the first predetermined threshold is about ±10 ms.

8. The system set forth in claim 1, wherein the second predetermined threshold is about ±25 ms.

9. The system set forth in claim 1, wherein the system comprises a portion of a television set.

10. The system set forth in claim 9, wherein the television set comprises a High Definition Television (HDTV) set.

11. A system that maintains synchronization between a video signal and an audio signal that are processed using clocks that are locked, the system comprising:
means for determining an initial audio input buffer level;
means for determining an amount of drift in the initial audio input buffer level;
means for adjusting the clocks to maintain the initial audio input buffer level if the amount of drift reaches a first predetermined threshold;
means for measuring a displacement of a video signal *associated with the audio signal in response to the adjusting of the clocks; and
means for negating the measured displacement of the video signal if the measured displacement reaches a second predetermined threshold.

12. The system set forth in claim 11, wherein the audio signal and the video signal comprise a Motion Picture Experts Group (MPEG) signal.

13. The system set forth in claim 11, wherein the means for measuring the displacement of the video signal associated with the audio signal operates to negate the measured displacement of the video signal by re-initializing the measurement of the initial audio input buffer level.

14. The system set forth in claim 11, wherein the means for measuring the displacement of the video signal associated with the audio signal operates to negate the measured displacement of the video signal by dropping a frame of the video signal.

15. A method for maintaining synchronization between a video signal and an audio signal that are processed using clocks that are locked, the method comprising:
determining an initial audio input buffer level;
determining an amount of drift in the initial audio input buffer level;
adjusting the clocks to maintain the initial audio input buffer level if the amount of drift reaches a first predetermined threshold;
measuring a displacement of a video signal associated with the audio signal in response to the adjusting of the clocks; and
negating the measured displacement of the video signal if the measured displacement reaches a second predetermined threshold.

16. The method set forth in claim 15, comprising storing the initial audio input buffer level in a memory.

17. The method set forth in claim 15, comprising disabling a clock recovery control if the amount of drift reaches the first predetermined threshold.

18. The method set forth in claim 15, wherein the act of negating the measured displacement of the video signal comprises re-initializing the measurement of the initial audio input buffer level.

19. The method set forth in claim 15, wherein the act of negating the measured displacement of the video signal comprises dropping a frame of the video signal.

20. The method set forth in claim 15, wherein the recited acts are performed in the recited order.
